(19) United States
(12) Patent Application Publication
(10) Pub. No.: US 2003/0042281 A1
(43) Pub. Date: Mar. 6, 2003

(54) Roof carrier for bicycle

(76) Inventor: Toshihiko Ishikura, Tokyo (JP)

Correspondence Address: VARNDELL & VARNDELL, PLLC, 106-A SOUTH COLUMBUS ST., ALEXANDRIA, VA, 22314, US

(21) Appl. No.: 10/231,261

(22) Filed: Aug. 30, 2002

(30) Foreign Application Priority Data
Sep. 3, 2001 (JP) P.2001-265766

(51) Int. Cl. B60R 9/048; B60R 9/00

(52) U.S. Cl. 224/319; 224/321; 224/324; 224/924

(57) ABSTRACT

A roof carrier has engagement portions at both sides of the intermediate portion of a bicycle receiver constituting a carrier main body portion. The one engagement portion is arranged in a manner that an erected arm is rotatable freely vertically and an engagement plate engages with the root portion of one of the pedals. The other engagement portion is arranged in a manner that the lower portion of a screw shaft is coupled to a buckle, and when a retainer hook provided at the tip end of the screw shaft is engaged with the root portion of the other pedal to fasten the buckle, the retainer hook engages-with the root portion of the pedal. A bicycle is strongly urged against the bicycle receiver by an engagement force between the engagement plate and the retainer hook.

### BACKGROUND OF THE INVENTION

1. Field of the Invention

The present invention relates to a roof carrier mounted on thereof a vehicle and, in particular, relates to a roof carrier for a bicycle for mounting a bicycle on the roof of a vehicle.

2. Description of the Related Art

The conventional roof carrier for mounting a bicycle on the roof of a vehicle is briefly classified into three kinds, that is, a fork down type, a frame clamp type and a crank arm clamp type.

As described in Japanese Utility Model Laid-Open No. 71312/1994, for example, the fork down type is arranged, in a manner that the front wheel of a bicycle is removed from a front wheel fork, then the axle attachment portion at the tip end of the front wheel fork is fitted to a fixing shaft provided at the roof carrier, and the tip end of the front wheel fork is fastened to the fixing shaft of the roof carrier by means of bolts etc.

As described in International Patent Publication No. 502140/1997 and Japanese Patent Laid-Open No. 289533/2000, the frame clamp type is arranged in a manner that a grip portion capable of being opened and closed freely is provided at the tip portions of a pair of arms which can be raised freely with respect to the main body portion of a roof carrier, and the frame of a bicycle is griped by the grip portion thereby to fix the bicycle to the roof carrier .

As described in U.S. Pat. No. 5,820,002, the crank arm clamp type is arranged in a manner that an arm capable of being raised freely with respect to the main body portion of a roof carrier is provided, and a crank arm for attaching the pedal of a bicycle thereto is gripped by a grip portion provided at the tip end portion of the arm thereby to fix the bicycle to the roof carrier.

However, according to the conventional fork down type roof carrier, the front wheel of the bicycle is required to be removed from the fork at the time of mounting the bicycle. Thus, not only the mounting operation of the bicycle is troublesome but also it is necessary to house the front wheel thus removed within a trunk of the vehicle etc. Further, in recent years, bicycles employing disk brakes have spread. In the bicycle provided with the disk brake, since a caliper constituting the disk brake remains on the front wheel fork side even if the front wheel is removed, the bicycle cannot be mounted on the fork down type roof carrier. Furthermore, at the time of braking the vehicle, for example, since the rear wheel rises due to the inertia of the bicycle, the rear wheel is required to be fixed to the main body portion of the roof carrier by using a belt etc.

According to the conventional frame clamp type roof carrier, the grip portion is usually configured to grip a circular thing and so cannot grip a unique frame such as a carbon frame having been spread recently. Thus, the conventional frame crank type roof carrier cannot mount a bicycle having a unique frame. Further, even if the frame is formed by a circular pipe etc., there are a bicycle having a thin frame like a road bicycle and a bicycle having a thick frame like a downhill bicycle. It is difficult to make the conventional frame crank type roof carrier cope with such various types frames. Furthermore, since the arm of the roof carrier provided with the grip portion can be raised freely with respect to the main body portion, at the time of braking the vehicle, for example, the arm may rotate due to the inertia of the bicycle and so the bicycle may float. Thus, the wheels of the bicycle are required to be fixed to the main body portion of the roof carrier by using a belt etc. Further, since a person cannot take the hand off the bicycle until mounting the bicycle on the roof carrier and fixing the bicycle thereto, the person must fix the bicycle using only one hand and so the fixing procedure cannot be performed easily. In recent years, bicycles with colored or painted frames have been increased. In such bicycles, when the frame is gripped by the grip portion, the frame is likely scraped or damaged and so the appearance of the bicycle is damaged or spoiled. A light-weight bicycle having a carbon frame etc. is relatively weak in its strength with respect to a force in a direction perpendicular to the axis line direction of the frame. Thus, in the case of gripping the frame to fix the bicycle, it is impossible to grip the frame with a force sufficient for fixing the bicycle.

According to the crank arm clamp type roof carrier, since a person cannot take the hand off the bicycle until mounting the bicycle on the roof carrier and fixing the bicycle thereto, the fixing operation is difficult. Further, since the crank arm clamp type roof carrier is configured to grip the crank arm at the one side of the bicycle, the bicycle is unstable with respect to the vibration in the direction perpendicular to the longitudinal direction of the bicycle. Thus, it is necessary to fix the wheel of the bicycle to the main body portion of the roof carrier by means of a belt. etc.

### SUMMARY OF THE INVENTION

The invention has been made in order to obviate the aforesaid problems of the conventional techniques and an object of the invention is to provide a roof carrier for a bicycle capable of mounting every kinds of bicycles.

Another object of the invention is to provide a roof carrier for a bicycle capable of eliminating an operation of supporting a bicycle by a hand so as to fix the bicycle.

A still another object of the invention is to provide a roof carrier for a bicycle capable of eliminating an auxiliary member such as a belt for fixing a wheel.

In order to attain the aforesaid objects, a roof carrier for a bicycle according to the invention includes: a carrier main body portion fixed on a roof of a vehicle; and engagement portions, provided at the carrier main body portion, for engaging left and right pedal portions provided at the bicycle, respectively.

The wording “pedal portion” includes a peripheral portion of a pedal attachment portion of the crank arm, that is, a portion of the crank arm in addition to the pedal portion.

At least one of the engagement portions can be formed to rotate vertically to be able to engage with and disengage from the pedal portion. Further, the engagement portion is preferably configured to push the pedal portion downward when engaged with the pedal portion.

According to the invention configured in the aforesaid manner, since the left and right pedal portions of the bicycle, for example, the root portion of the pedal (the portion between the pedal and a crank arm) is engaged by the engagement portion, the invention can easily and surely mount the bicycle on the vehicle even if the bicycle is one having a disk brake or a grotesque frame unlike the frame crank type and the fork down type. Further, since the left and right pedal portions are engaged, the stability of the fixing and holding of the bicycle can be enhanced.

Further, according to the invention, since at least one of the engagement portions is rotated to make it possible to engage with or disengage from the pedal portion, the engagement state with the pedal portion can be released by merely rotating the engagement portion and so the bicycle can be unloaded easily from the roof of a vehicle. Further, since the pedal portion is pressed downward when the engagement portion engages with the pedal portion, the bicycle is urged downward. Thus, when the pedal portion is engaged by the one of the engagement portions, the bicycle is prevented from falling down even if a person leaves the hands from the bicycle. Thus, not only the fixing operation of a bicycle can be performed by using both hands easily and quickly, but also the bicycle can be fixed stably even when a vehicle jolts or is braked and so an auxiliary member such as a belt for fixing the wheels is not required.

### BRIEF DESCRIPTION OF THE DRAWINGS

FIG. 1 is a perspective view showing a using state of the roof carrier for a bicycle according to the first embodiment of the invention;

FIG. 2 is a detailed diagram for explaining the main portion of the roof carrier for a bicycle according to the first embodiment;

FIG. 3 is a detailed diagram for explaining the positioning mechanism of one of the engagement portions of the roof carrier for a bicycle according to the first embodiment;

FIG. 4 is a perspective view of an engagement plate portion constituting the one engagement portions of the roof carrier for a bicycle according to the first embodiment;

FIG. 5 is a perspective view of a buckle provided at the other engagement portions of the roof carrier for a bicycle according to the first embodiment;

FIG. 6 is a perspective view showing a state where the lock cover of the roof carrier for a bicycle according to the first embodiment is removed;

FIG. 7 is a perspective view showing a tire base according to the first embodiment;

FIG. 8 is a diagram for explaining another engagement method using the retainer hook of the roof carrier for a bicycle according to the first embodiment;

FIG. 9 is a diagram for explaining the roof carrier for a bicycle according to the second embodiment of the invention;

FIG. 10 is a diagram for explaining the roof carrier for a bicycle according to the third embodiment of the invention;

FIGS. 11A and 11B are diagrams for explaining the positioning mechanism of one of the engagement portions of the roof carrier for a bicycle according to the fourth embodiment; and

FIG. 12 is a diagram for explaining an accommodating condition of the engagement portions of the roof carrier for a bicycle according to the present invention.

### DETAILED DESCRIPTION OF THE PREFERRED EMBODIMENTS

The preferred embodiments of a roof carrier for a bicycle according to the invention will be explained in detail with reference to the accompanying drawings.

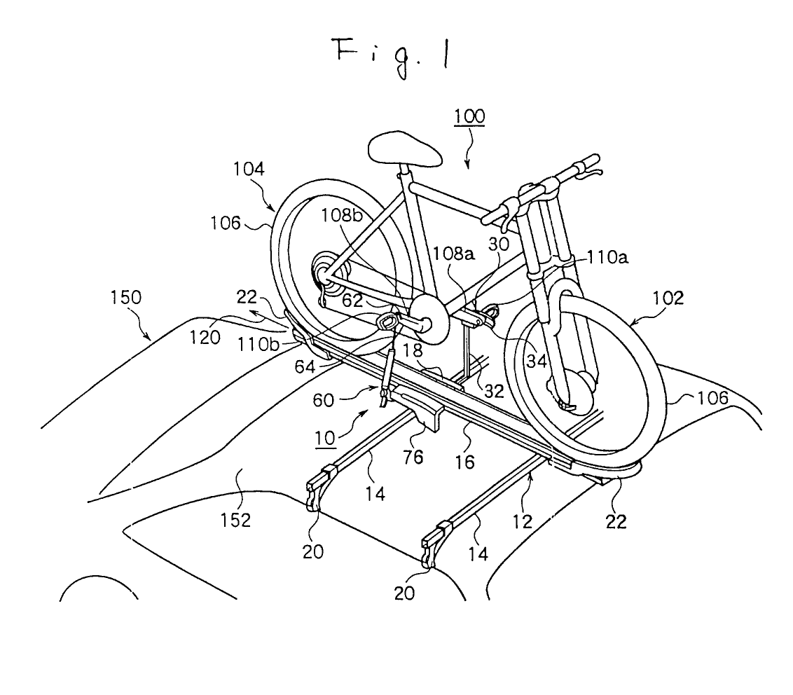

FIG. 1 is a perspective view showing a using state of the roof carrier for a bicycle according to the first embodiment of the invention. In FIG. 1, a roof carrier 10 is arranged in a manner that a carrier main body portion 12 includes a plurality of (two in the embodiment) base bars 14, a bicycle receiver 16 on which a bicycle is disposed and an attachment base 18 to which the bicycle receiver 16 is fixed. The base bars 14 are disposed in a direction perpendicular to the longitudinal direction of a vehicle 150 on the roof panel 152 of the vehicle 150 and fixed to the vehicle 150 through brackets 20 attached to roof side rails (not shown) of the vehicle 150.

The bicycle receiver 16 is disposed so as to be orthogonal to the base bars 14 on the pair of the base bars 14 and fixed to the base bars 14 by means of screws etc. That is, the bicycle receiver 16 is fixed at the lower portion of the longitudinal center portion thereof to an attachment base 18 thereby to be fixed to the one of the base bars 14 through the attachment base 18. The bicycle receiver 16 has a length sufficient for disposing thereon both the front wheel 102 and the rear wheel 104 of the bicycle 100.

The bicycle receiver 16 is configured in a tub shape such as a U-shape, a V-shape, a reverse-trapezoidal shape etc. in its transversal section so that the tires 106 of the bicycle 100 can be inserted therein, whereby the bicycle 100 is prevented from shifting in the direction perpendicular to the longitudinal direction of the vehicle 150 and is easily kept in a standing state. Tire bases 22 described later in detail are attached at the both end portions of the bicycle receiver 16 along the longitudinal direction thereof so that the bicycle receiver 16 is movable along the bicycle receiver 16, whereby the positioning operation of the bicycle 100 along its longitudinal direction can be performed easily at the time of disposing the bicycle 100 on the bicycle receiver 16.

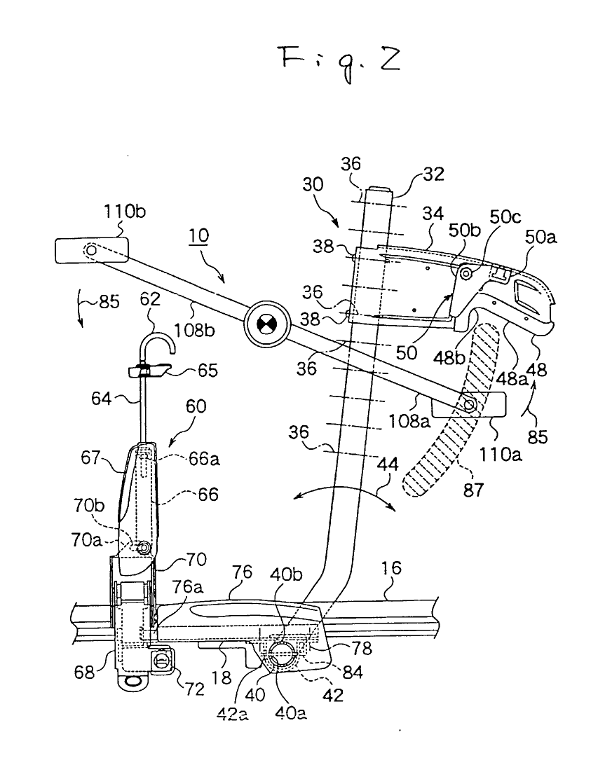

Engagement portions 30, 60 for fixing the bicycle 100 on the bicycle receiver 16 are provided at the both sides of the attachment base 18. The one engagement portion 30 has an erected arm 32 formed by a pipe bent in an L-shape and an engagement plate 34 attached to the erected arm 32 so as to be detachable freely. As shown in FIG. 2, a plurality of adjustment screw holes 36 are formed at the erected arm 32 along the longitudinal direction thereof. The engagement plate 34 is configured to be attached to the erected arm 32 by means of locking screws 38. The attachment position (the position along the vertical direction) of the engagement plate 34 to the erected arm 32 can be changed arbitrarily by changing the screwing positions of the locking screws 38 to the adjustment screw holes 36.

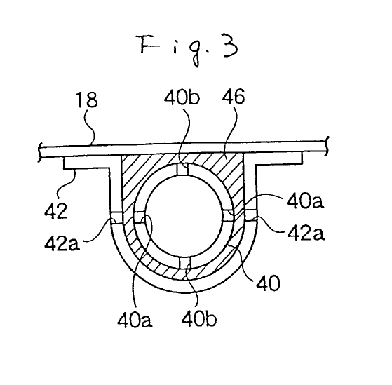

The erected arm 32 is arranged in a manner that a lower end portion 40 thereof bent in the horizontal direction is inserted into a reverse-Ω shaped bracket 42 provided at the lower surface of the attachment base 18 so as to be able to rotate (raise) freely in the vertical direction as shown by an arrow 44. As shown in FIG. 3, at the tip end of the lower end portion 40 of the erected arm 32, four key grooves 40a, 40a, 40b, 40b are formed around the center of the lower end portion with an interval of 90 degrees. At the end surface of the bracket 42, a pair of key grooves 42a corresponding to the key grooves 40a, 40b of the lower end portion 40 are provided at the both sides of the center of the curvature.

When the engagement portion 30 is erected at the engagement position for engaging the pedal portion of the bicycle 100, the pair of key grooves 40a provided at the lower end portion 40 are positioned at the positions corresponding to the key grooves 42a of the bracket 42, and a plate-shaped key provided at a cover described later enters the key grooves 40a, 42a thereby to fix the engagement portion 30 to the engagement position. On the other hand, when the engagement portion 30 is laid down in an almost horizontal state, the pair of key grooves 40b provided at the lower end portion 40 are positioned at the positions corresponding to the key grooves 42a of the bracket 42, and the plate-shaped key provided at the cover enters the key grooves 40b, 42a thereby to fix the engagement portion 30 to the laid-down position. A reference numeral 46 shown in FIG. 3 depicts a bearing formed by resin etc. disposed between the lower end portion 40 of the erected arm 32 and the bracket 42.

An engagement jaw portion 48 is provided at the tip end side of the engagement plate 34. The lower portion of the engagement jaw portion 48 forms a guide 48a which tip end side is slanted downward. Further, the lower portion of the base end portion of the engagement jaw portion 48 forms an engagement portion 48b. As shown in FIG. 1, the root portion (the portion between a crank arm 108a and a pedal 110a) of the pedal 110a attached to the one of the crank arms 108a of the bicycle 100 is engaged with the engagement portion 48b.

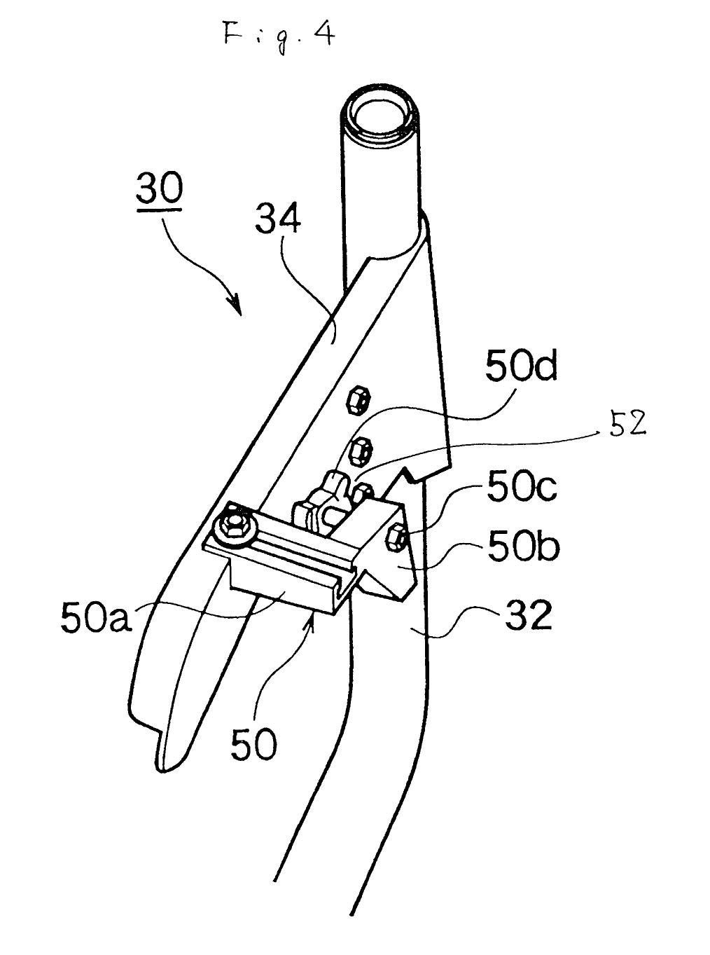

A crank restriction member 50 is protrusively provided at the engagement plate 34 on the vehicle body side of the bicycle 100. As shown in FIG. 4, the crank restriction member 50 is formed in an L-shape when seen from the horizontal direction and includes an arm portion 50a provided at the engagement plate 34 protrusively in the horizontal direction and a restriction plate 50b attached at the tip end side of the arm portion 50a. In the crank restriction member 50, a crank receiving groove 52 is formed between the engagement plate 34 and the restriction plate 50b. A restriction screw 50c is screwed at the upper portion of the restriction plate 50b. A crank receiving gap formed between the tip end of the restriction screw 50c and the engagement plate 34 can be adjusted in accordance with the width (thickness) of the arm 108 by changing the screwing depth of the restriction screw 50c. Further, a lock knob 50d is secured at the tip end side of the restriction screw 50c in a manner that the screwing depth of the restriction screw 50c can be kept constant by fastening the lock knob 50d.

As shown in FIG. 2, the other engagement portion 60 is provided with a retainer hook 62 at the tip end portion thereof in a manner that the retainer hook 62 is latched or engaged with the root portion (the portion between the arm 108b and the pedal 110b) of the pedal 110b attached to the other arm 108b of the bicycle 100 (see FIG. 1). The retainer hook 62 is provided at the tip end portion of a screw shaft 64. A disengage-prevention lever 65 is provided at the screw shaft 64 on the lower side of the retainer hook 62 so as to be rotatable freely. The disengage-prevention lever 65 is automatically positioned just beneath the retainer hook 62 by a torsion spring (not shown) when no external force acts on the lever and the root portion of the pedal 110b latched or engaged with the retainer hook 62 does not disengage therefrom even if vibration etc of the vehicle 150 acts thereon.

The screw shaft 64 is screwed into a nut 66a which lower end portion is fixed to a coupling member 66 so that the length of the screw shaft 64 protruding from the coupling member 66 is changed by rotating the screw shaft 64 thereby to adjust the vertical position of the retainer hook 62.

As shown in FIG. 5, a buckle 68 is protrusively provided at the side surface of the one side end portion of the attachment base 18. The buckle 68 includes a base 68a and an operation lever 68b pivotally attached to the base 68a. A frame 70 is attached to the center portion of the operation lever 68b so as to be rotatable freely. A coupling portion 70a is provided at the tip end portion of the frame 70. As shown in FIG. 2, the base end portion of the coupling member 66 is pivotally attached to the coupling portion 70a. An elongated hole 70b is formed at the coupling portion 70a so that the portion 66 can move in the left and right direction in FIG. 2, that is, the longitudinal direction of the bicycle 100 through a pin for pivotally attaching the coupling member 66.

A lock 72 is provided at the side portion of the operation lever 68b of the buckle 68. The lock 72 is arranged in a manner that when a key 74 inserted into the lock 72 is rotated in a state that the operation lever 68b is rotated downward to fasten the buckle 68, a tip end engagement portion 72a engages with an engagement portion (not shown) provided at the attachment base 18 to disable the operation of the buckle 68 thereby to hold a lock cover 76 in a closed state. The coupling member 66 is arranged to be covered by a protection cover 67.

As shown in FIG. 2, the lock cover 76 is pivotally attached to the attachment base 18 through a pin 78 at the outer side end portion of the right side in the figure (the forward side of the bicycle 100) in a manner that the lock cover is rotatable within the horizontal plane around the pin 78. An engagement piece 76a is protrusively provided at the outer side end portion of the lock cover 76 on the opposite side of the pivotally attached point. When the lock cover 76 is closed as shown in FIG. 2, the tip end portion of the engagement piece 76a is disposed at the position corresponding to the buckle 68. Then, when the buckle 68 is fastened by the operation lever 68b to place the buckle 68 in a locked state, the operation lever 68b covers the tip end portion of the engagement piece 76a. Thus, the lock cover 76 cannot be opened so long as the fastening state of the buckle 68 is released.

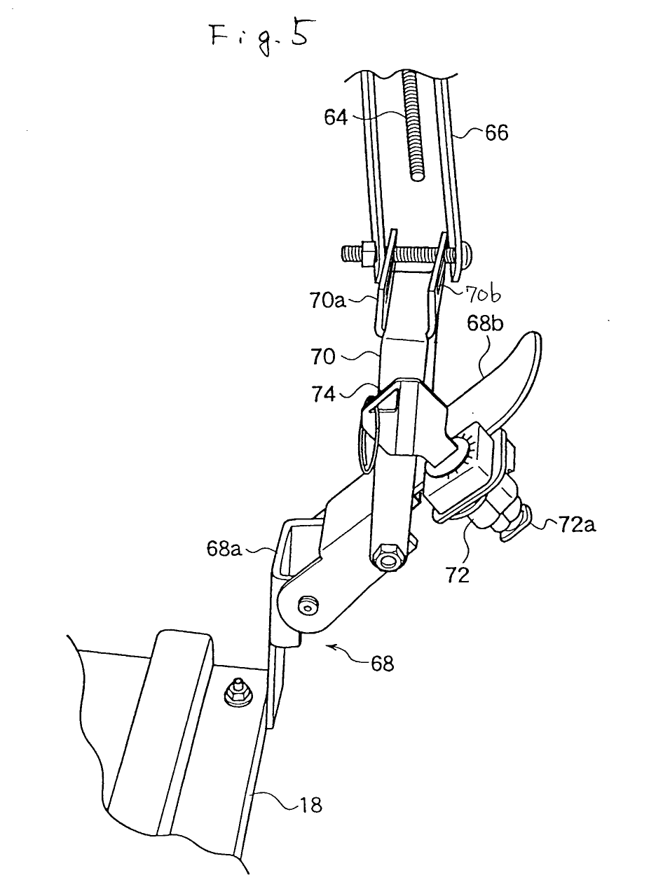

As shown in FIG. 6, the attachment base 18 has at its lower portion a pair of U-bolts 80. The pair of the U-bolts 80 are used for fixing the attachment base 18, that is, the bicycle receiver 16 to the base bars 14 and disposed at the both sides of the bicycle receiver 16, respectively. In each of the U-bolts 80, screw portions at the both ends thereof pass through the attachment base 18 and protrude to the upper side of the attachment base 18. Fastening knobs 82 are secured to the screw portions in a manner that the attachment base 18 is fixed to the base bars 14 or the coupling state between the attachment base 18 and the base bars 14 is released by rotating the fastening knob 82. The lock cover 76 is arranged to cover the fastening knob 82 positioned on the engagement portion 60 side of the bicycle receiver 16 when closed as shown in FIG. 2, so that the bicycle can be prevented from being stolen .

The lock cover 76 is provided with a plate shaped key 84 at the inner surface thereof in the vicinity of the pivotally attaching point to the attachment base 18 (see FIG. 2). When the lock cover 76 is closed, the plate shaped key 84 enters the key grooves 40a, 40b, 42a provided at the lower end portion 40 of the erected arm 32 and the bracket 42 thereby to prevent the rotation of the erected arm 32, that is, the engagement portion 30.

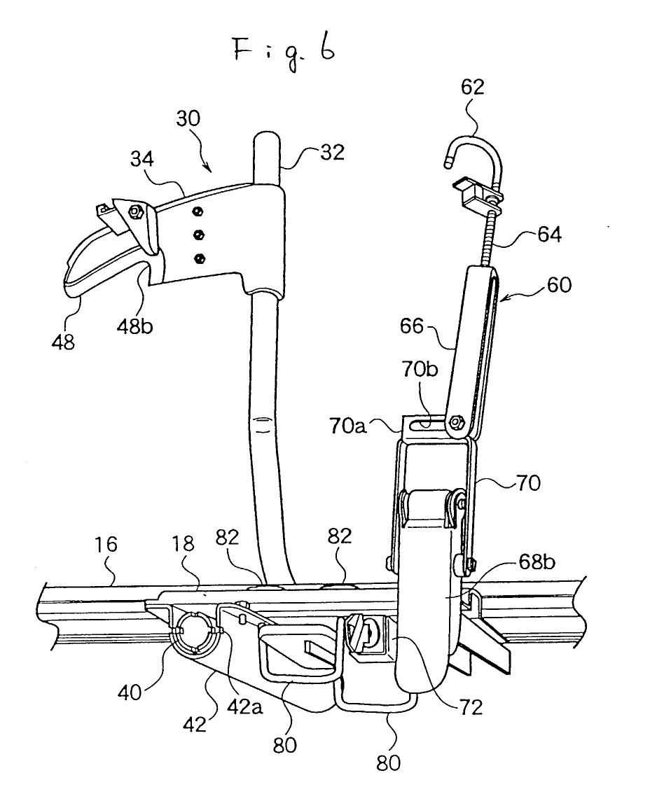

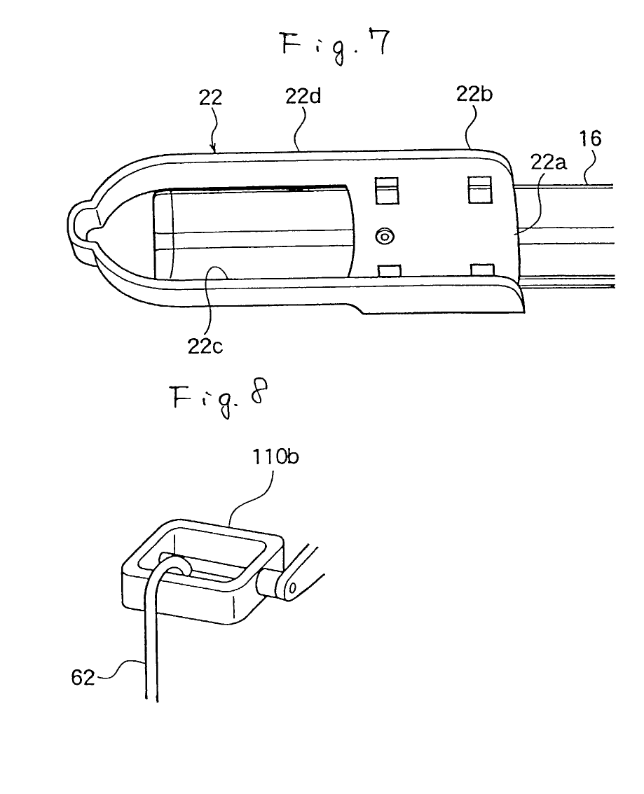

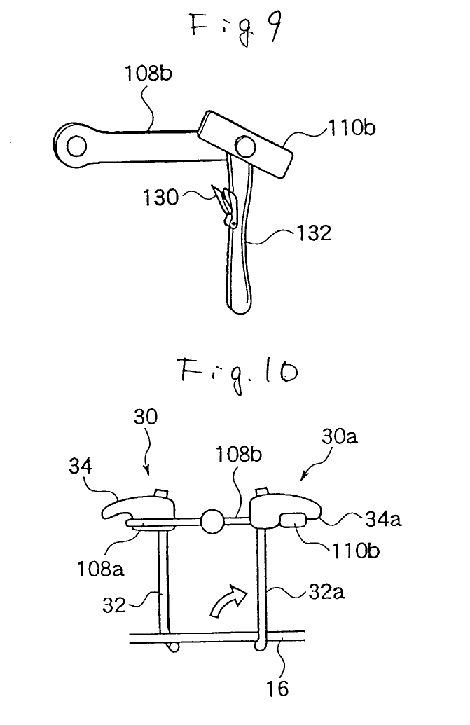

As shown in FIG. 7, the one end side (the base end side) of the tire base 22 serves as a fitting slide portion 22b having a bottom portion 22a disposed along the upper surface of the bicycle receiver 16. The fitting slide portion 22b is fitted on the outer surface of the bicycle receiver 16, so that the tire base is attached to the bicycle receiver 16 so as to be slideable there along. The tip end side of the tire base 22 has no bottom portion and so serves as a tire disposing portion 22c exposing the upper surface of the bicycle receiver 16. A tire supporting wall 22d is provided in an almost U-shape at the periphery of the tire disposing portion 22c. That is, the tire supporting wall 22d is provided at the both side portions and the tip end side of the tire disposing portion 22c but not provided on the base end portion side.

According to the roof carrier 10 of the embodiment thus configured, the bicycle receiver 16 constituting the carrier main body portion 12 is attached integrally with the attachment base 18 to the base bars 14 fixed on the roof of the vehicle 150 through the U-bolts 80 and the fastening knobs 82 provided at the attachment base 18. When the bicycle 100 is not mounted on the roof carrier 10, the one engagement portion 30 of the roof carrier 10 is laid almost in the horizontal direction, so that the pair of the key grooves 40b provided at the lower end portion 40 of the erected arm 32 are disposed at the positions corresponding to the key grooves 42a formed at the bracket 42. When the lock cover 76 is closed, the plate 84 provided at the lock cover 76 enters the key grooves 40b, 42a thereby to fix the engagement portion 30 at its laid position. The other engagement portion 60 of the roof carrier 10 is arranged to make the retainer hook 62 hold with and fix to the hook engagement portion (not shown).

The loading and unloading of the bicycle 100 on and from the roof carrier 10 is performed in the following manner.

Loading of the Bicycle

First, the locking state of the lock 72 provided at the buckle 68 is released by using the key 74 and the lock cover 76 is opened to release the fixing state of the engagement portion 30. Further, the retainer hook 62 of the engagement portion 60 is disengaged from the hook engagement portion (not shown). Then, one of the engagement portions is raised and rotated to erect at the engagement position, then the lock cover 76 is closed to fix the engagement portion 30 at the engagement position (see FIG. 12). Further, as shown in FIG. 2, the pedal 110a on the one engagement portion 30 side is disposed on the front side of the bicycle 100 rather than the pedal 110b, and the pedal 110a is disposed at the lower position than the pedal 110b so that the root portion of the pedal 110a disposed at the lower position than the engaging position. That is, the tip end portion of the crank arm 108a is disposed near an area 87 shown by slanted lines in FIG. 2.

Thereafter, a person holds the frame of the bicycle 100 by the hand and disposes the front wheel 102 and the rear wheel 104 of the bicycle 100 at the positions of the tire bases 22 attached to the bicycle receiver 16, respectively. Next, the person holds the bicycle 100 in a standing state by using the one hand. Then, the person holds the pedal 100 by using the other hand and rotates the arm 108 in a reverse direction (the direction where the one-way clutch of the bicycle 100 idles), that is, counterclockwise as shown by an arrow 85 in FIG. 2, thereby engaging the portion (the root portion) between the crank arm 108a and the pedal 110a with the engagement portion 48b of the engagement portion 30. In this case, the root portion of the pedal 110a is pressed downward with a large force by the engagement plate 34 and so the bicycle 100 is urged against the bicycle receiver 16, whereby the bicycle 100 strongly engages with the bicycle receiver to such an extent that the bicycle does not fall down even if the person leaves the hands from the bicycle 100.

When the root portion of the pedal 110a is engaged by the engagement plate 34 of the engagement portion 30 in this manner, the root portion of the pedal 110a is pressed downward by the engagement plate 34 to apply to the crank arm 108a a force for rotating the rear wheel 104 in the forward-traveling direction of the bicycle 100. However, since the bicycle 100 is strongly urged against the bicycle receiver 16, the crank arm 108a is kept in a state of being engaged by the engagement plate 34 without rotating.

Incidentally, the screwing length of the restriction screw 50c provided at the crank restriction member 50 is adjusted in advance in such a degree that the gap between the tip end of the restriction screw 50c and the engagement plate 34 can receive the crank arm 108a but the crank arm 108a does not so wobble transversally.

When the root portion of the pedal 110a is engaged by the engagement plate 34 of the engagement portion 30 in this manner, the root portion is pressed downward with a large force by the engagement plate 34 and so the bicycle 100 is strongly urged against the bicycle receiver 16, so that the bicycle 100 can be held in a standing state even if the person leaves the hands from the bicycle. Thus, the disengage-prevention lever 65 provided at the screw shaft 64 of the other engagement portion 60 is rotated to open the opening portion of the retainer hook 62 thereby to make the retainer hook 62 engage with the root portion of the other pedal 110b. Then, when the force having been acted on the disengage-prevention lever 65 is released, the disengage-prevention lever 65 automatically restores to the position closing the opening of the retainer hook 62 by the torsion spring as shown in FIG. 2.

Then, the operation lever 68b of the buckle 68 is rotated downward to fasten the buckle 68. Thus, since the retainer hook 62 is coupled to the operation lever 68b through the frame 70, the coupling member 66 and the screw shaft 64, the retainer hook is drawn downward by the downward rotation of the operation lever 68b to urge the root portion of the pedal 110b downward. That is, when the operation lever 68b is rotated downward, the retainer hook 62 presses the root portion of the pedal 110b in the direction where the arm 108 races and presses the root portion of the pedal 110a on the other side against the engagement portion 48b of the engagement plate 34 with a stronger force. Thus, the bicycle 100 is placed in a state of being urged on the bicycle receiver 16 and so fixed firmly thereon.

The height of the retainer hook 62, that is, the protruding length of the screw shaft 64 from the coupling member 66 is adjusted in advance, together with the vertical position of the engagement plate 34 constituting the engagement portion 30, in a manner that when the root portions of the pedals 110a and 110b are engaged by the engagement plate 34 and the retainer hook 62, a sufficient downward pressing force is applied to these root portions.

Thereafter, the lock 72 is locked by the key 74 so that the releasing operation of the buckle 68 cannot be performed. Thus, the tip end portion of the engagement piece 76a provided at the lock cover 76 is kept in a state of being covered by the operation lever 68b, so that the lock cover 76 covering the fastening knob 82 cannot be opened and so the bicycle can be prevented from being stolen.

In this manner, since the roof carrier 10 of the embodiment is arranged to engage the root portions of the left and right pedals 110 (110a , 110b) of the bicycle 100, every kinds of bicycles irrespective of the kinds thereof such as ones having disk brakes or grotesque frames can be mounted on a vehicle 150. Further, in this embodiment, when the root portion of the portion 110a of the bicycle 100 is engaged by the engagement plate 34 of the engagement portion 30, the root portion is pressed downward by the engagement plate 34 and so the bicycle 100 is urged against the bicycle receiver 16. Thus, since the bicycle does not fall down even if the person leaves the hands from the bicycle 100, the person can perform the fixing operation of the bicycle using the both hands, so that the fixing operation of the bicycle 100 can be performed easily and quickly. Further, according to the roof carrier 10 of the embodiment, since the bicycle 100 is fixed in a state that the bicycle is urged against the bicycle receiver 16, the bicycle 100 can be held in a stably fixed state even if vibration of the vehicle 150 acts on the bicycle 100 or the vehicle 150 jolts transversally or is braked. Thus, an auxiliary member such as a belt for fixing the wheels 102, 104 of the bicycle 100 to the roof carrier 10 is not required. Therefore, the number of parts of the roof carrier can be made smaller and so the management of the parts becomes easier, and further a time required for mounting the bicycle 100 can be reduced.

Further, according to the embodiment, since the pedal portions on which a force pedaling the bicycle 100 directly acts are made engaged, it is possible to act a large force for the engagement on the bicycle, the bicycle 100 can be fixed suitably. Further, since the roof carrier 10 according to the embodiment is arranged to support the bicycle at two points in a manner that the root portions of the left and right pedals 110 of the bicycle 100 are engaged, the roof carrier can exhibit high stability with respect to the vibration caused by the running of the vehicle 150 etc. Furthermore, according to the embodiment, since the height of the engagement plate 34 of the engagement portion 30 and the height of the retainer hook 62 of the engagement portion 60 can be adjusted freely, the roof carrier can easily cope with any height of the attachment position of the pedals 110. Further, the transversal wobbling of the crank arm 108a can be prevented by adjusting the screwing length of the restriction screw 50c provided at the crank restriction member 50, so that the bicycle 100 mounted on the vehicle can be prevented from jolting transversally.

Unloading of the Bicycle

The unloading of the bicycle 100 from the roof carrier 10 is performed in the following manner. First, the key 74 is inserted into the lock 72 to release the locked state of the lock 72. Then, the operation lever 68b of the buckle 68 is rotated upward to release the buckle 68. Then, the disengage-prevention lever 65 of the engagement portion 60 is rotated to disengage the retainer hook 62 from the root portion of the pedal 110b. Next, the person supports the bicycle 100 by one hand and opens the lock cover 76 to place the erected arm 32 of the one engagement portion 30 in a rotatable state. Thereafter, the one engagement portion 30 is rotated to the rear side of the bicycle 100. That is, when the erected arm 32 of the one engagement portion 30 is rotated to the rear side of the bicycle 100, the root portion of the pedal 100a moves relatively with respect to the engagement plate 34 and disengages from the engagement jaw portion 48, whereby it becomes possible to unload the bicycle 100 from the roof carrier 10. Then, when the bicycle 100 is unloaded from the roof carrier 10, the erected arm 32 is laid down at the horizontal position, then the lock cover 76 is closed and locked by the key 74.

In this manner, according to the embodiment, the bicycle 100 is placed in a state of being unloaded easily by laying the one engagement portion 30, so that the unloading operation of the bicycle 100 can be performed easily and quickly.

The embodiment described above is one mode of the invention and the invention is not limited thereto. For example, although, in the aforesaid embodiment, the explanation has been made as to a case where the retainer hook 62 of the other engagement portion 60 is engaged with the root portion of the pedal 110b, the retainer hook 62 may be engaged with the pedal 100b itself as shown in FIG. 8. Further, although, in the aforesaid embodiment, the other engagement portion 60 is configured to provide the retainer hook 62 at the tip end of the screw shaft 64, the root portion of the pedal 110b may be engaged by a string belt 132 having a buckle 130 as shown in FIG. 9.

Further, although, in the aforesaid embodiment, the explanation has been made as to a case where the other engagement portion 60 is configured to have the retainer hook 62, the invention may be arranged in a manner that the other engagement portion is formed as an engagement portion 30a configured in the similar manner as the one engagement portion 30 and the root portion of the pedal 110b is engaged by the engagement plate 34a of the an engagement portion 30a. In this case, the invention may be arranged in a manner that the engagement plate 34 or 34a of the one engagement portion 30 or the other engagement portion 30a is slideable along the erected arm 32 or an erected arm 32a and can be fixed at a desired position or that when the erected arm 32 or the erected arm 32a is rotated and erected at thee engagement position, the erected arm 32 or the erected arm 32a is moved downward by a cam mechanism etc. and so the engagement plate 34 or the engagement plate 34a pushes the pedal portion downward.

Furthermore, although, in the aforesaid embodiment, the explanation has been made as to a case where the one engagement portion 30 is rotated on the backward side of the bicycle 100 to release the engagement at the time of unloading the bicycle 100, the tire base 22 engaging the rear wheel 104 of the bicycle 100 may be slid backward as shown in an arrow 120 in FIG. 1. When the tire base 22 of the rear wheel 104 side is moved backward, the bottom portion 22a of the tire base 22 forcedly rotates the tire 106 of the rear wheel 104 in the running direction of the bicycle 100, so that the engagement state of the engagement portion 30 can be released.

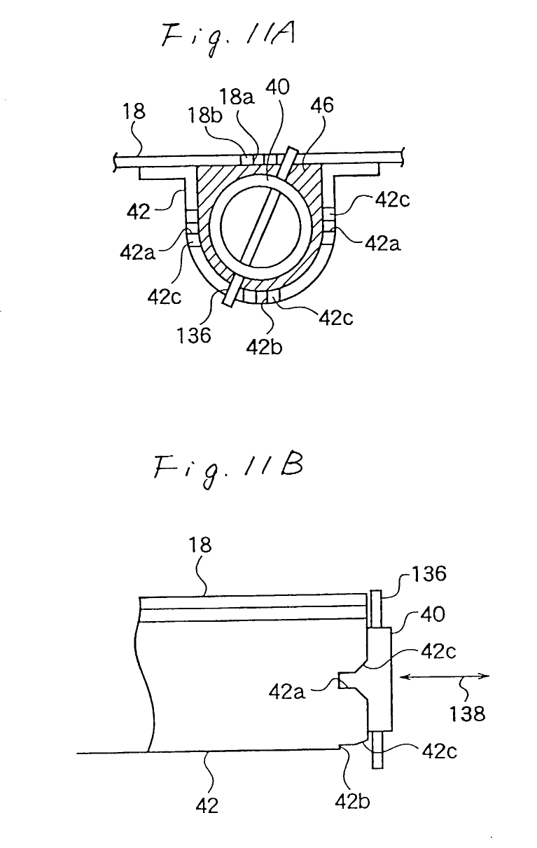

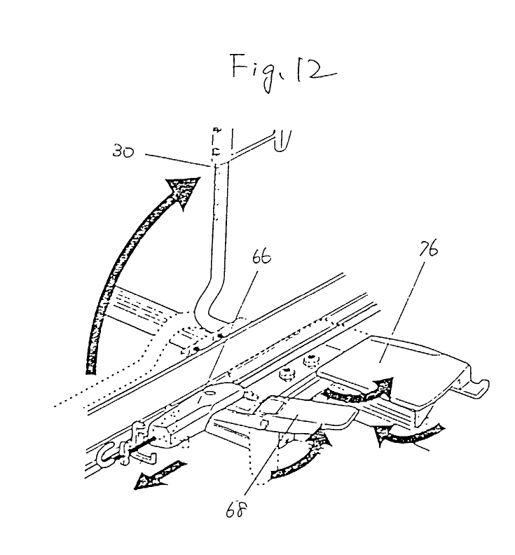

Furthermore, in the aforesaid embodiment, the explanation has been made as to a case where, at the time of fixing the engagement portion 30 to the engagement position and the laid position, the key grooves 40a, 40b are formed at the end surfaces of the lower end portion 40 of the erected arm 32 and the plate shaped key 84 provided at the lock cover 76 enters the key grooves 40a, 40b. The invention may be arranged in a manner that, as shown in FIG. 11A, a pin 136 serving as a key is provided at the lower end portion 40 and the pin 136 enters the key grooves 42a, 42b of the bracket 42 and the key groove 18a of the attachment base 18.

That is, the erected arm 32 of the engagement portion 30 is formed so as to be movable in the direction perpendicular to the longitudinal direction of the bicycle receiver 16 as shown by an arrow 138 in FIG. 11B and a pin 136 is provided at the lower end portion 40 so as to protrude in the diametrical direction. Further, the bracket 40 is provided with a pair of the key grooves 42a in the horizontal direction and also provided with a key groove 42b at the lower end portion. Further, a key groove 18a is formed at the position of the attachment base 18 corresponding to the key groove 42b. The reference numerals 18b, 42c shown in FIG. 11 depict guide portions for guiding the key 136 to the key grooves 40a, 42b, 18a.

Furthermore, although, in the aforesaid embodiment, the explanation has been made as to a case where the tire bases 22 are attached to the bicycle receiver 16, the tire bases 22 may not be provided. Furthermore, although, in the aforesaid embodiment, the explanation has been made as to a case where both the front wheel 102 and the rear wheel 104 of the bicycle 100 are disposed on the bicycle receiver 16, the invention may be arranged to dispose only one of the wheels (for example, the rear wheel 104) on the bicycle receiver.

As described above, according to the invention, since the left and right pedal portions of the bicycle, for example, the root portion of the pedal is engaged by the engagement portion, the invention can easily and surely mount the bicycle on the vehicle even if the bicycle is one having a disk brake or a grotesque frame unlike the frame crank type and the fork down type.

Further, according to the invention, since at least one of the engagement portions is rotated to make it possible to engage with or disengage from the pedal portion, the engagement state with the pedal portion can be released by merely rotating the engagement portion and so the bicycle can be unloaded easily from the roof of a vehicle. Further, since the pedal portion is pressed downward when the engagement portion engages with the pedal portion, the bicycle is urged downward. Thus, when the pedal portion is engaged by the one of the engagement portions, the bicycle is prevented from falling down even if a person leaves the hands from the bicycle. Thus, not only the fixing operation of a bicycle can be performed by using both hands easily and quickly, but also the bicycle can be fixed stably even when a vehicle jolts or is braked and so an auxiliary member such as a belt for fixing the wheels is not required.

What is claimed is:

1. A roof carrier for a bicycle comprising:
a carrier main body portion fixed on a roof of a vehicle; and
a plurality of engagement portions provided at the carrier main body portion and engaging left and right pedal portions of the bicycle, respectively.

2. The roof carrier for a bicycle according to claim 1, wherein at least one of the engagement portions rotates vertically so as to engage with and disengage from the pedal portion.

3. The roof carrier for a bicycle according to claim 1, wherein the engagement portion pushes the pedal portion downward when the engagement portion is engaged with the pedal portion.

4. The roof carrier for a bicycle according to claim 1, wherein the carrier main body portion includes:
a bicycle receiver receiving the bicycle therein; and
an attachment base for fixing the bicycle receiver to the vehicle, and
wherein the plurality of engagement portions are respectively attached to the attachment base.

5. The roof carrier for a bicycle according to claim 1, wherein the engagement portions comprises a first engagement portion including: an arm member which is bent in an L-shape; and an engagement plate extending longitudinally from one end of the arm member and engageable with the pedal portion,
wherein the other end of the arm member is supported to the carrier main body portion so that the arm member is tiltable around the other end thereof.

6. The roof carrier for a bicycle according to claim 5, further comprising:
a lock cover having a key engageable with a key groove provided in the other end of the arm member, for fixing the position of the first engagement portion.

7. The roof carrier for a bicycle according to claim 6, wherein the engagement portions comprises a second engagement portion including: a hook member retaining the pedal portion; and a buckle for regulating the hook member vertically.

8. The roof carrier for a bicycle according to claim 7, wherein the lock cover is secured by covering a front portion thereof with an operation lever of the buckle, whereby the first engagement portion is positioned.

9. The roof carrier for a bicycle according to claim 1, wherein the engagement portion comprise:
a hook portion retaining the pedal portion;
a connecting member connected with the hook portion;
a frame connected with the connecting member so that the connecting member is tiltable in a longitudinal direction of the vehicle; and
a buckle having an operation lever connected with the frame at an intermediate portion thereof so that the frame is tiltable in a width direction of the vehicle,
wherein the hook portion and the connecting member are held along the carrier main body when the buckle is fastened.
